(19) United States
(12) Patent Application Publication
(10) Pub. No.: US 2003/0053481 A1
(43) Pub. Date: Mar. 20, 2003

(54) Packet processor and packet processor system

(76) Inventors: Kenichi Abiru, Kawasaki (JP); Tetsumei Tsuruoka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/124,828

(22) Filed: Apr. 18, 2002

(30) Foreign Application Priority Data
Sep. 18, 2001 (JP) 2001-283999

(51) Int. Cl. H04J 3/16

(52) U.S. Cl. 370/465; 370/501

(57) ABSTRACT

In a packet processor and a packet processor system for performing predetermined packet processing for an inputted packet in a packet relaying apparatus or the like, a packet data holder sequentially receives a packet from its head; an execution program holder holds a program in which a processing procedure of the packet is described; and a program execution controller determines a command number of a program to be executed based on a provided packet length and the program, and controls an execution of the program. Also, the program execution controller instructs the program execution controller of at least one of the packet processors at a preceding stage and a following stage of a command acquisition timing and a command acquisition position.

### BACKGROUND OF THE INVENTION

1. Field of the Invention

The present invention relates to a packet processor and a packet processor system, and in particular to a packet processor and a packet processor system for performing predetermined packet processing to an inputted packet in a packet relaying apparatus or the like.

With a recent development of communication technology, a global network system has been constructed where private networks such as LAN (Local Area Network) are mutually connected for exchanging data between computers and various information processing hardware (terminals).

Communications in the global network system are performed according to various communication protocols for each layer in e.g. an OSI (Open Systems Interconnection) model. Presently, mainstream communication protocols in a layer corresponding to a transport layer/network layer of the OSI model are respectively TCP/IP (Transport Control Protocol/Internet Protocol) protocols.

Communications between terminals by the TCP/IP protocols are performed with a packet composed of data and header information. The IP protocol is of a connection-less type, and the packet relaying apparatus such as a router mutually connecting the LAN's routes the packet to a destination terminal. For this reason, it is required to perform packet processing such as retrieval processing of a destination table and header rewrite processing based on the header information of the packet.

2. Description of the Related Art

For the packet processing in the IP protocol, in addition to the above-mentioned destination table retrieval processing and the header rewrite processing, there are mentioned processing necessary for relaying a packet such as a checksum calculation of a header of an inputted packet or the like, and packet filtering processing for limiting the communication of the network, or the like. Also, the packet processing depends on the various protocols for layers.

If a special circuit for the packet processing corresponding to the various protocols for layers is composed of only hardwares, the circuit composition is complicated. In addition, it is extremely difficult to accommodate to a change of a processing procedure associated with a revision of a protocol itself.

Therefore, in order to accommodate to the various protocols and the revision of the protocol itself, the packet processing has been generally subject to software processing by a general-purpose processor.

[1] Packet Processor

FIG. 12 shows an arrangement of a prior art general-purpose processor 102, which is composed of an arithmetic unit 10, an internal general-purpose register 11, an internal state holder 12, a controller 13, and an external bus buffer 14. Also, an external memory 120 is connected to the processor 102 by a bus 110.

An input packet 201 is temporarily stored in the memory 120. The processor 102 reads the packet 201 or the part of the packet 201 from the memory 120 into the internal general-purpose register 11, executes predetermined packet processing in the form of software, and writes the processed data in the external memory from the internal general-purpose register 11, so that a packet 202 is reconstructed from the packet 201. This packet 202 is outputted to e.g. a switch fabric (not shown) at a next stage included in the packet relaying apparatus through the bus 110.

In such packet processing composed of the general-purpose processor 102, the external memory 120, and the bus 110, an overhead is caused by an access (write/read) of the input packet 201/output packet 202 for the memory 120 through the bus 110, and an access (read/write) of the input packet 201/output packet 202 stored in the memory 120 from the processor 102 through the same bus 110.

In addition to the overhead, there has been a problem that speedup of the packet processing is difficult due to limitation of an access bandwidth of the memory 120 itself.

In order to solve this problem, a packet processor 101 in Japanese Patent Application Laid-open No. 2000-349816 shown in FIG. 13 is provided with a packet data access register (included in a packet data holder 70; not shown) for directly capturing the input packet 201 instead of the above-mentioned memory 120.

Namely, the processor 101 is composed of the arithmetic unit 10, the internal general-purpose register 11, an execution program holder 20, a program start-up unit 30a, a controller 40a, an internal state holder 50, a packet data input unit 60, the packet data holder 70, a packet data output unit 80, and an intermediate data holder 90.

Hereinafter, the operation of each component will be described.

The packet data input unit 60 detects the arrival of the receiving packet 201 by an external packet arrival signal 221, and synchronizes the packet 201 with a transfer clock from the head of the packet to be sequentially and directly stored in a packet data access register group (not shown) within the packet data holder 70.

The program start-up unit 30a synchronizes with a receiving packet transfer timing signal 222 from the packet data input unit 60 to start up the program.

The packet data holder 70 stores a part or all of the packet data inputted from the packet data input unit 60 in the register. The intermediate data holder 90 is provided with a register group (not shown) for storing a processing result for the packet data.

Any of these registers with which the holders 70 and 90 are provided can be accessed from the program. The data held by the registers of the packet data holder 70 and the intermediate data holder 90 are sequentially shifted to the next register within the register group in synchronization with the transfer clock, and are outputted to the packet data output unit 80.

The packet data output unit 80 sequentially transmits the packet 202 forming a processing result for the input packet 201 to the outside of the processor 101.

The arithmetic unit 10 performs various operations such as four operations of arithmetic. The internal general-purpose register 11 works with the program. The arithmetic unit 10 can use the internal general-purpose register 11, and the registers of the holders 70 and 90. The result (carry flag etc.) of the operations is sequentially held in the internal state holder 50 as an internal state.

The execution program holder 20 holds a program composed of commands to be executed (e.g. microcode etc.).

The controller 40a starts the acquisition of commands from the execution program holder 20 by a start-up instruction signal 233 from the program start-up unit 30a, decodes the acquired commands, and determines the processing. For example, a program bank value is switched over, and an arithmetic for a predetermined register and the processing of the data transfer are executed, so that the following state is determined according to the internal state of each unit. The internal state is held in the internal state holder 50.

The controller 40a increments a program counter by “1”, acquires the next command, and repeats the execution of the processing corresponding to the command. The controller 40a executes a predetermined number of commands, ends the operation, and waits for the start-up instruction signal 233 for the next packet.

FIG. 14 shows an example of a program execution control for acquiring a command in more detail. This program execution control is performed by a +1 adder 35 and a program counter 33 included in the controller 40. A memory 21 included in the execution program holder 20 is composed of L number of banks 0, 1, . . . , L−1, and the switchover of the banks is performed by a bank switchover signal 224 from the controller 40a.

The executable maximum command number N of microcodes for a single packet can be stored in the banks 0−(L−1) in the processor 101. The microcodes are composed of conditions and commands, and can be acquired by providing a memory address 225 and the bank switchover signal 224 to the memory 21.

The program counter 33 which outputs the memory address 225 is initialized to an address 0, is incremented by “1” for every command execution clock at the +1 adder 35 after the start of the command execution, and sequentially designates an address 1, an address 2, . . . , an address N−1.

Also, the bank switchover signal 224 outputs the bank 0 at the initial state, and switches over signals respectively designating the bank 1, the bank L−1, . . . e.g. at the time when the program counter 33 indicates the address 4, the address 6, . . . after the start of the command execution. As a result, the command is selected in the order of microcodes MC0, MC1, . . . , MC4, . . . , MC6, MC7, . . . to be executed.

The input packet 201 is stored in the register of the packet data holder 70 through the input unit 60, so that the packet processing is performed to the data and the header information of the packet based on the microcodes MC0, MC1, . . . .

At this time, the header information and the data of the packet 201 are accessed by the arithmetic unit 10 and the internal general-purpose register 11 at a high speed, thereby resolving the overhead of read/write processing for packet data between the processor 102 and the memory 120 shown in FIG. 12.

The packet processor 101 has a flexibility of not only realizing high-speed packet processing but also enabling a description of a packet processing procedure by the microcodes held in the execution program holder.

[2] Packet Processor System

In a packet processor system of Japanese Patent Application No. 2000-373732 shown in FIG. 15, the packet processors 101_1, 101_2, . . . (hereinafter, occasionally represented by a reference numeral 101) shown in FIG. 13 are connected in series, where the packet processing result outputs (packet 202, intermediate data, internal state 234, etc.) of the packet processor 101 at a present stage are made a data input of the packet processor 101 at a preceding stage.

The “preceding stage” and “following stage” of the packet processor in the packet processor system are defined, based on FIGS. 8A and 8B, as follows: When a certain packet 201 receives attention in a group of a plurality of packet processors 100 sequentially started up for the packet 201 shifting within the packet data holder (packet register) 70, the packet processor 100 driven to the head of the packet at present is made reference (a present stage), the packet processor at the following stage indicates the packet processor 100 started up in the past on a time-base, and the packet processor at the preceding stage indicates the packet processor 100 driven in the future on a time-base.

In this packet processor system, pipelining is achieved that the packet processing is divided and the command steps of the divided processing are allocated to the packet processor 101 when the command step number of the program is large since predetermined packet processing is complicated, for example.

Thus, the command step number for a single packet processor 101 is kept equal to or less than a predetermined value, thereby enabling a high-speed and programmable packet processing with a highly required throughput being maintained.

[1] Packet Processor

An executable command number N by the prior art packet processor 101 for a single packet is a limited value determined by a request throughput, a command execution clock rate, a data transfer width in the packet data holder 70, and its transfer clock rate.

This value becomes smaller as e.g. the request throughput becomes faster, so that the packet processing contents executed by the processor 101 are limited.

Also, since the packet processor 101 starts up the program in synchronization with the packet arrival signal 221 indicating the arrival of the packet 201, the packet data range accessible is also limited by the command execution clock rate, the data transfer width in the packet data holder 70, and the transfer clock rate.

Namely, the packet data from its head to the position which can be stored in the packet data holder 70 while the executable step number of commands are executed form the accessible range. Accordingly, the larger the data transfer width/transfer clock rate/register (included in the packet data holder 70) stage number of the packet data holding mechanism is, the wider the accessible packet range becomes. However, the register width/stage number is a limited value finally determined in consideration of the hardware scale or the like.

Accordingly, there has been a problem that when upper protocols or data contents are required to be accessed in e.g. a network model having a hierarchical structure, the executable command number and the accessible packet range are limited.

[2] Packet Processor System

Therefore, when the command number necessary for the packet processing exceeds the executable command number, the packet processor system shown in FIG. 15 has been composed as a second prior art such that the executable command number for a single packet is increased by the pipelining method.

However, there are problems that the executable command number (command step number) per packet processor 101 is finite in the packet processor system shown in FIG. 15, so that the executable command number and the accessible packet range are restricted.

Accordingly, the processing amount of whole the packet processor system where the packet processors 101 are connected in series has a limited command step number in a physical device level. Only the processing executable within redundant steps can accommodate to a functional addition after hardware manufacturing, shipment of products, or the like.

In consideration of the functional addition in the future, in the presence of a possibility that processing exceeding the executable command step number is required in a mounted hardware, it is necessary to connect devices in a multi-stage on a device-basis in order to secure a sufficient command step number.

However, much of the packet processing is sufficient with basic processing. Additionally mounting the hardware (device) for option processing and the functional addition in the future is not expedient in aspect of the hardware scale and the cost.

As mentioned above, each protocol of the network has a hierarchical structure, so that packets transmitting data have the hierarchical structure. Furthermore, some packets of a specific protocol have a variable length header structure.

There are protocols such as an IPv6 (Internet Protocol version6) protocol and an MPLS (Multi-Protocol Label Switching) protocol in addition to an IPv4 (Internet Protocol version4) protocol which is the mainstream at present.

FIG. 16A shows a header of the IPv4 protocol, which is composed of fields of a version, an Internet header length, a type of service, a total length, an identification, flags, a fragment offset, a time to live, a protocol, a header checksum, a source address, a destination address, options (variable), and a padding.

In the Internet header length (IHI) field, information indicating the length of the IP header itself is set. By this information, the header length of the IPv4 can be recognized.

FIG. 16B shows a header of the IPv6 protocol, which is composed of fields of a version, a priority, a flow label, a payload length, a next header, a hop limit, a source address, and a destination address. Its length is fixed 40 bytes.

When an extension header is used, information indicating the type of the extension header following the IPv6 header is set in the next header field.

FIG. 16C shows an extension header example of the IPv6 protocol, which is composed of fields of a next header, a header extension length, and the like. The length of the extension header is an arbitrary byte length of 8 bytes×“n”, and its length is set in the field of the header extension length.

When the extension header is further used, information indicating the type of the extension header following its own header is set in the next header field, and when the extension header is not used, an upper protocol No. is set.

In order to recognize the length of the IPv6 header including the IPv6 extension header, whether or not the IPv6 extension header follows the IPv6 header, and what type of IPv6 extension header follows when it follows are identified referring to the “next header field” of the IPv6 extension header shown in FIG. 16B. Also, the length of the present extension header is recognized by the value of the “header extension length field”.

Furthermore, referring to the next header field of the extension header shown in FIG. 16C, whether or not the IPv6 extension header further follows, and what type of IPv6 extension header follows when it follows are identified. Until the time when no extension header follows, the identification is repeated, thereby enabling the length of the IP header including the extension header to be recognized.

Similarly, it becomes possible to access the data in a predetermined field of a packet having a fixed or variable length header.

FIG. 17A shows a shim header of an MPLS. The shim header is composed of fields of a label, reserved for experiment, an S bit, and a time to live (TTL). In this shim header, whether the shim header further follows or a payload follows is identified referring to the S bit, so that the whole length of a sequential shim header can be recognized.

FIG. 17B shows a header of the TCP protocol. This header is composed of fields of a source port No, a destination port No, a sequence No, a reception acknowledgement No, a data offset, a reserved, a control flag, a window, a checksum, an urgent pointer, options, and a padding.

FIG. 18 shows an example of a hierarchized packet. In this example, the TCP packet at the upper layer is accommodated in the data (payload) field of the IPv6 packet. Also, the IPv6 header is composed of an IPv6 basic header (fixed length, see FIG. 16B) and the IPv6 extension header (arbitrary length, see FIG. 16C) of an arbitrary number of stages.

In order to recognize the start position of the packet at the upper layer and its type (while the type is a TCP packet in FIG. 18, there is a case where the type is a UDP (User Datagram Protocol) packet, or the like) from the head position of the IPv6 packet thus hierarchized, it is necessary to recognize the header length by the above-mentioned procedure.

Therefore, it is generally required for the packet processor 101 to perform processing according to the format of the packet determined by each protocol. In a case that the above-mentioned extension header is repeated, for example, it is required to repeat typical processing.

FIG. 19 shows a program counter 33 and a program adder 34 included in the controller 40a of the packet processor 101, and a memory 21 included in the execution program holder 20.

A command (microcode) set of the packet processor 101 can be made a function set necessary for performing the packet processing at a high speed by the composition of the hardware. For example, it is possible to make e.g. the microcode, which designates a jump, “con” (execution condition of jump command)+“jmp” (mnemonic indicating jump command)+“r (i)” (operand designating the position of jumping destination). It is possible to designate the position of the jumping destination by a relative position or absolute position.

When the operand r (i) of the microcode=“positive increment value (relative position)”, the adder 34 sets the value, obtained by adding the increment value to the present value of the program counter 33, to the program counter 33. Namely, the program jumps back to the command position by the increment value before the present execution position.

This means that the commands are not executed from the present execution position to the command position after the jump execution.

On the other hand, the case where the operand r (i) of the microcode=“negative increment value (relative position)” means that the commands are repeated from the position of the jump command execution to the position before the execution.

FIGS. 20A and 20B respectively show a flow example in which the same command is repeated. FIG. 20A shows a flow in which the jump command at step T13 is con=“No”, and the relative position=“negative”. FIG. 20B shows a flow in which the jump command at step T23 is con=“unconditioned”, and the relative position=“negative”.

In a general processor, repeat processing is realized by combining the jump commands.

However, in the prior art packet processor system, the packet processor 101 after executing a predetermined command number starts the processing only by the arrival of the next packet. This means that the packet processors 101 at the “preceding stage” and “following stage” of the packet processor 101 executing processing for a single packet at present are in a state where the processing for the packet is stopped.

Accordingly, there has been a problem that a branch command of a program spanning a plurality of packet processors 101 can be neither described nor executed.

### SUMMARY OF THE INVENTION

It is accordingly an object of the present invention to provide a packet processor and a packet processor system which perform predetermined packet processing for an inputted packet, wherein an executable command number is increased, an accessible packet range is enlarged, branch processing is made easy, and a programming of packet processing is flexibly described.

In order to achieve the above-mentioned object, the packet processor of the present invention comprises: a packet register for sequentially receiving a packet from its head; an execution program holder for holding a program in which a processing procedure of the packet is described; and a program execution controller for determining a command number of a program to be executed based on a provided packet length and the program, and for controlling an execution of the program. (claim 1)

Firstly, the principle of the present invention will be described. The time when a packet passes through one point of a packet register elongates in proportion to a packet length. Namely, the time when the packet processor can access the packet elongates.

Accordingly, depending on processing contents of a program and the position within the packet accessed by this processing, it becomes possible to increase the executable command number and enlarge the accessible packet range.

Therefore, the packet processor of the present invention is provided with not only an arithmetic unit, an internal general-purpose register, and a command executing unit which a general processor has, but also a packet register which can be directly accessed, an execution program holder, and a program execution controller. The execution program holder holds a program in which a processing procedure of the packet is described. The packet register sequentially receives the packet from its head. The program execution controller determines a command number to be executed based on the packet length provided from the inside or outside and the program to control the execution of the program.

Thus, it becomes possible to increase the executable command number and to enlarge the accessible packet range.

Also, the packet processor system of the present invention comprises: at least two packet processors connected in cascade; each of the processors including a packet register for sequentially receiving a packet from its head, an execution program holder for holding a program in which a processing procedure of the packet is described, a program execution controller for determining a command number to be executed, based on a provided packet length and the program, and for controlling an execution of the program, and an internal state holder for holding an internal state; the internal state of the packet processor at a present stage and an output packet being provided to the packet processor at a preceding stage. (claim 2)

Namely, the packet processor is provided with not only an arithmetic unit, an internal general-purpose register, and a command executing unit which a general processor has, but also a packet register, an execution program holder, and a program execution controller, and further an internal state holder for holding an internal state.

At least two packet processors are connected in cascade to compose the packet processor system, whereby the internal state of the packet processor at a present stage and the output packet are provided to the packet processor at a preceding stage, which executes the packet processing of the output packet inputted based on the internal state.

Thus, it becomes possible to increase the executable command number for a single packet and enlarge the accessible range as the whole of the packet processor system.

Also, the packet processor system of the present invention comprises: at least two packet processors connected in cascade so that an output packet of the packet processor at a present stage is provided to the packet processor at a preceding stage; each of the processors including a packet register for sequentially receiving a packet from its head, an execution program holder for holding a program in which a processing procedure of the packet is described, and a program execution controller for controlling an execution of the program; the program execution controller of the packet processor at the present stage instructing the program execution controller of at least one of the packet processors at the preceding stage and a following stage of a command acquisition timing and a command acquisition position. (claim 3)

Namely, the packet processor is provided with not only an arithmetic unit, an internal general-purpose register, and a command executing unit which a general processor has, but also a packet register, an execution program holder, and a program execution controller.

At least two packet processors are connected in cascade to compose the packet processor system. In this system, there are cases where only a packet processor at a preceding stage is connected to a packet processor at a present stage, the packet processors at both of the preceding and the following stages are connected to the packet processor at the present stage, and only the packet processor at the following stage is connected to the packet processor at the present stage.

The program execution controller of the packet processor at the present stage instructs the program execution controller of the connected packet processor of a command acquisition timing and a command acquisition position.

Thus, it becomes possible to describe and execute the branch command of the program spanning the packet processors, thereby enabling the programming of the packet processing to be flexibly performed.

Also, in the packet processor system of the present invention according to the above-mentioned invention, the program execution controller may determine a command number of a program to be executed based on a provided packet length and the program. (claim 4)

Thus, it becomes possible to increase the executable command number, to enlarge the accessible packet range, and to decrease e.g. the packet processing stage number, based on the packet length and the program contents.

Also, in the packet processor system of the present invention according to the above-mentioned invention, the packet processor may further include an internal state holder for holding an internal state, and the internal state of the packet processor at the present stage may be provided to the packet processor at the preceding stage. (claim 5)

Thus, it becomes easy to connect the packet processors.

Also, in the packet processor system of the present invention according to the above-mentioned invention, the execution program holder may be capable of switching over a bank, and the internal state may comprise a bank value. (claims 6 and 19)

Namely, the execution program holder can switch over the bank. For example, the execution program holders at the present and the preceding stages hold a series of program spanning the same bank. The packet process at the present stage notifies the bank value stored in the program executed presently to the packet processor at the preceding stage.

Thus, the packet processors at the present/preceding stages can select and execute the series of program based on the bank value.

Also, in the present invention according to the above-mentioned invention, by a finish of a packet in processing or an input of a new packet, the program execution controller may stop acquiring a next command for the packet. (claims 7, 8, and 20)

Namely, when a packet in processing finishes in the packet register, the processing to the packet can not be executed. Also, when a new packet is inputted, the processing to the new packet has to be started. Therefore, the program execution controller stops acquiring the command for the packet in processing at present.

Thus, it becomes possible to eliminate an insignificant packet processing operation and to reliably start the packet processing for the next new packet.

Also, in the present invention according to the above-mentioned invention, the program execution controller may not execute a command acquisition for predetermined command execution clocks. (claims 9, 10, and 21)

Namely, the program execution controller does not execute the command acquisition for predetermined command execution clocks between the present command acquisition and the next command acquisition. For these predetermined command execution clocks, the packet shifts within the packet register.

Thus, when the field of the packet to be processed by the next command comes to the position of the packet register to be processed within the packet register, the program execution controller can execute the command acquisition so that the next command may be executed.

As a result, the command which performs nothing except shifting the packet within the packet register becomes unnecessary, so that the command number decreases. It becomes possible to flexibly perform the programming of the packet processing.

Also, in the present invention according to the above-mentioned invention, the program execution controller may not execute a command acquisition for predetermined command execution clocks after a transfer timing signal indicating a timing when the packet is inputted is received. (claims 11, 12, and 13)

Thus, it becomes unnecessary to make the program start position the head of the program, thereby enabling the packet processing program to be flexibly described.

It is to be noted that the predetermined command execution clocks may comprise a command acquisition position. (claim 14)

Thus, it becomes easy to describe the branched program spanning the packet processors.

Also, in the present invention according to the above-mentioned invention, the program execution controller may determine a command acquisition position based on an internal state of the packet processor itself and the program. (claims 15, 16, and 22)

Furthermore, in the present invention according to the above-mentioned invention, the internal state may comprise an allowable command number or an executable command number. (claims 17 and 18)

By these inventions, it becomes possible to flexibly describe the packet processing program.

### BRIEF DESCRIPTION OF THE DRAWINGS

FIG. 1 is a block diagram showing an embodiment of a packet processor according to the present invention;

FIG. 2 is a block diagram showing in more detail an execution program holder, a packet data holder, and a program execution controller in a packet processor according to the present invention;

FIG. 3 is a diagram showing an example of a program execution control in a packet processor according to the present invention;

FIGS. 4A and 4B are diagrams showing an example of a command execution timing (bank switchover and command acquisition (1)) in a packet processor according to the present invention;

FIG. 5 is a block diagram showing an embodiment (1) of a packet processor system according to the present invention;

FIG. 6 is a block diagram showing an embodiment (2) of a packet processor system according to the present invention;

FIG. 7 is a block diagram showing an arrangement of a program execution controller in a packet processor system according to the present invention;

FIGS. 8A and 8B are diagrams showing an example of a command execution order based on a branch command in a packet processor system according to the present invention;

FIGS. 9A and 9B are diagrams showing an example of a command execution timing (command acquisition (2)) in a packet processor system according to the present invention;

FIGS. 10A and 10B are diagrams showing an example of a TCP port No. acquisition algorithm included in an IPv6 packet in a packet processor according to the present invention;

FIGS. 11A-11D are diagrams showing an example of a TCP port No. acquisition included in an IPv6 packet in a packet processor according to the present invention;

FIG. 12 is a block diagram showing an arrangement (1) of a prior art packet processor;

FIG. 13 is a block diagram showing an arrangement (2) of a prior art packet processor;

FIG. 14 is a diagram showing a program execution control of a prior art packet processor;

FIG. 15 is a block diagram showing an arrangement of a prior art packet processor system;

FIGS. 16A-16C are format diagrams of a general IP header;

FIGS. 17A and 17B are format diagrams of general shim header and TCP header;

FIG. 18 is a diagram showing an arrangement of an IPv6 header including a general TCP packet;

FIG. 19 is a schematic diagram showing a branch command of a general packet processor; and

FIGS. 20A and 20B are flow charts showing a flow of general repetition processing.

Throughout the figures, like reference numerals indicate like or corresponding components.

### DESCRIPTION OF THE EMBODIMENTS

[1] Embodiment of Packet Processor

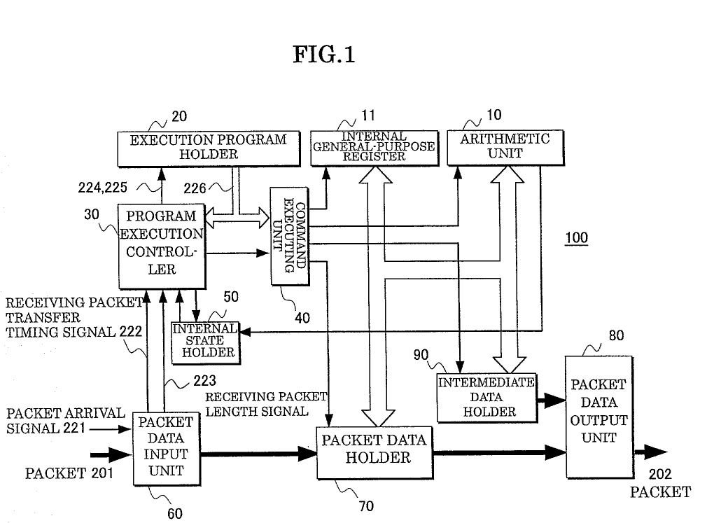

FIG. 1 shows an embodiment of a packet processor 100 according to the present invention. This processor 100 is different from the prior art processor 101 shown in FIG. 13 in that a program execution controller 30 and a command executing unit 40 are substituted for the prior art program start-up unit 30a and the controller 40a.

In addition, the processor 100 is different from the processor 101 in that the program execution controller 30 receives a receiving packet length signal 223 from the packet data input unit 60.

The basic operation in which the program execution controller 30 and the command executing unit 40 are combined is the same as the operation in which the program start-up unit 30a and the controller 40a are combined. However, the processor 100 is different from the prior art processor 101 in that the program execution controller 30 can change the command number of the execution program based on the receiving packet length signal 223, the receiving packet transfer timing signal 222 of the packet, or the like.

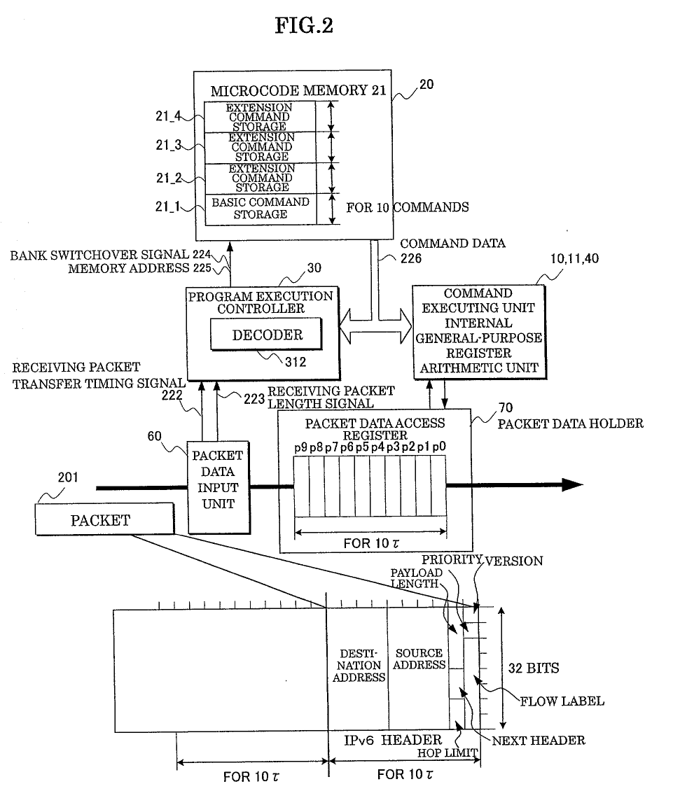

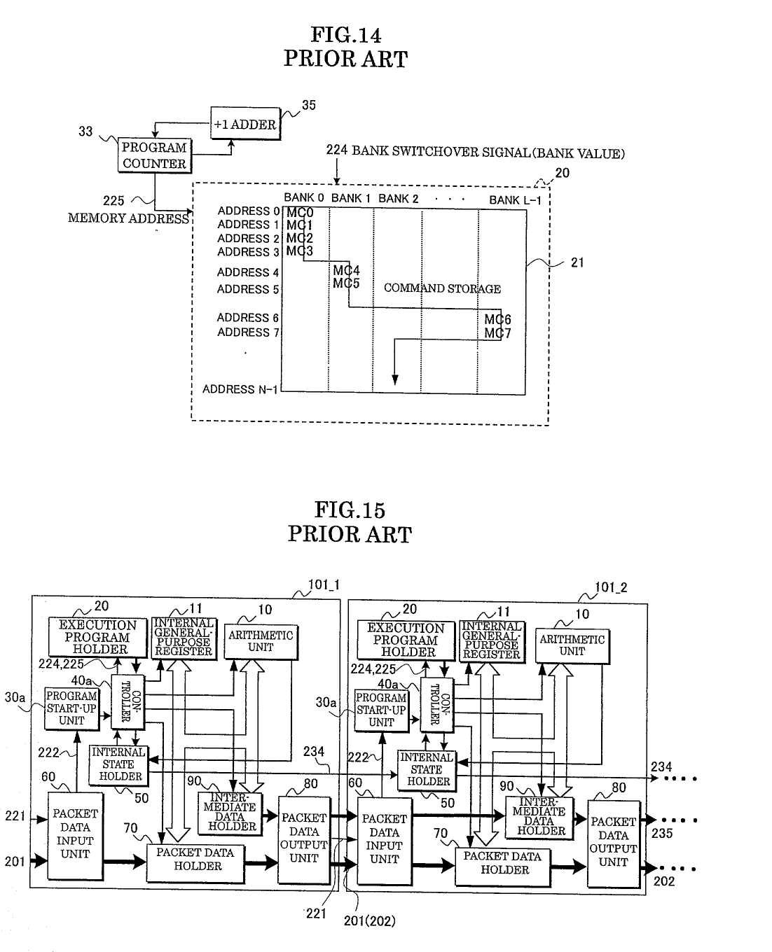

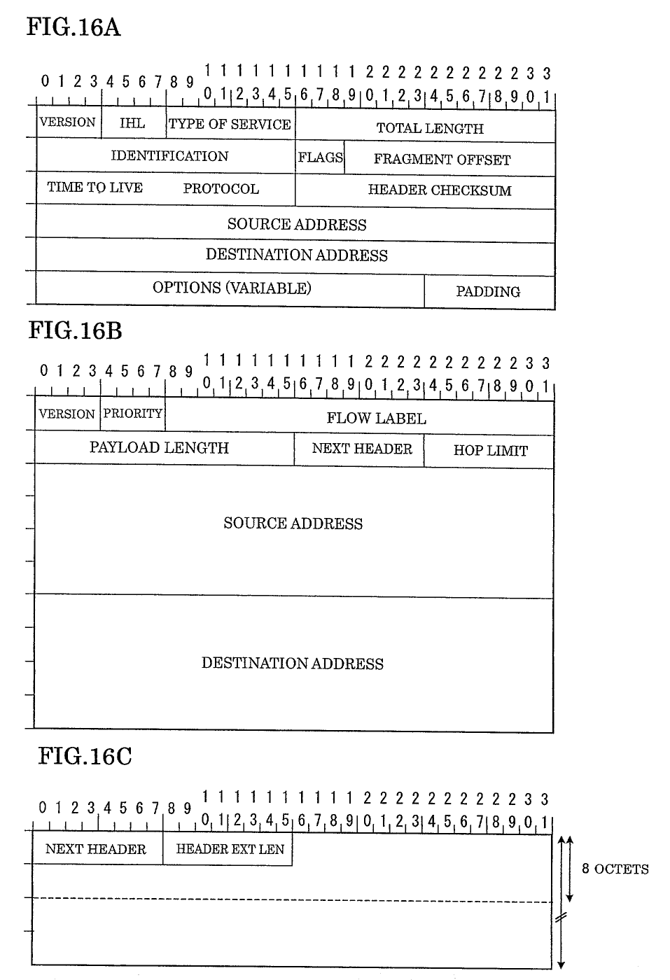

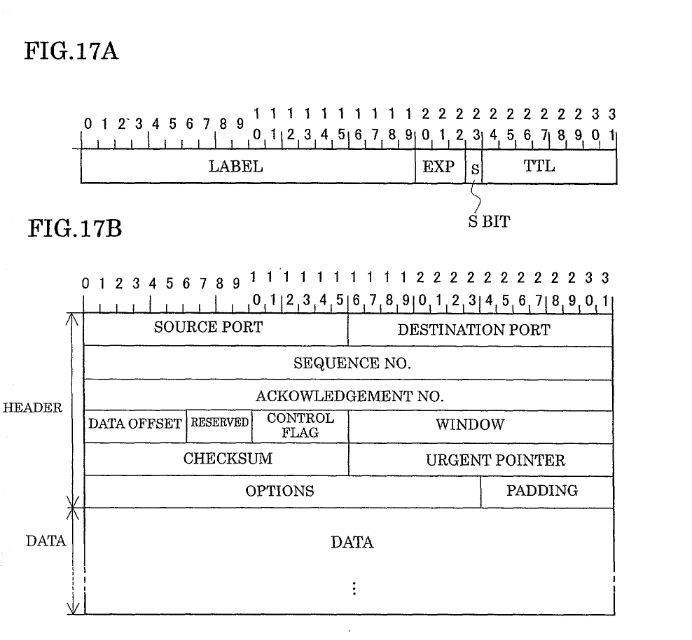

FIG. 2 shows an arrangement of the above-mentioned execution program holder 20, program execution controller 30, and packet data holder 70. A microcode memory 21 of the execution program holder 20 includes extension command storages 21_2-21_4 in addition to a basic command storage 21_1 corresponding to the memory 21 of the prior art memory shown in FIG. 14.

In the basic command storage 21_1, executable number N=“10” commands (microcodes) with a predetermined throughput being maintained are stored in the same way as the prior art memory 21. In the extension command storages 21_2-21_4, extension commands (microcodes) are stored. Whether or not the extension commands in the storages 21_2-21_4 are executed depends on the instructions from the program execution controller 30.

The program execution controller 30 is provided with a decoder 312. The packet data holder 70 is provided with packet data access registers p0-p9.

The packet data input unit 60, in the same way as the prior art input unit 60, detects the arrival of the receiving packet 201 by the external packet arrival signal 221, and synchronizes the receiving packet 201 with a clock from the head of the packet to be sequentially and directly stored in the registers p9-p0.

Furthermore, the input unit 60, different from the prior art input unit 60, outputs the receiving packet length signal 223 besides the receiving packet transfer timing signal 222 to the program execution controller 30. This receiving packet length signal 223 is held until new packet data are outputted to the packet data holder 70.

It is to be noted that the receiving packet length signal 223 may be measured and obtained at the packet data input unit 60, or may be directly provided to the program execution controller 30 from the outside in synchronization with the input of the packet.

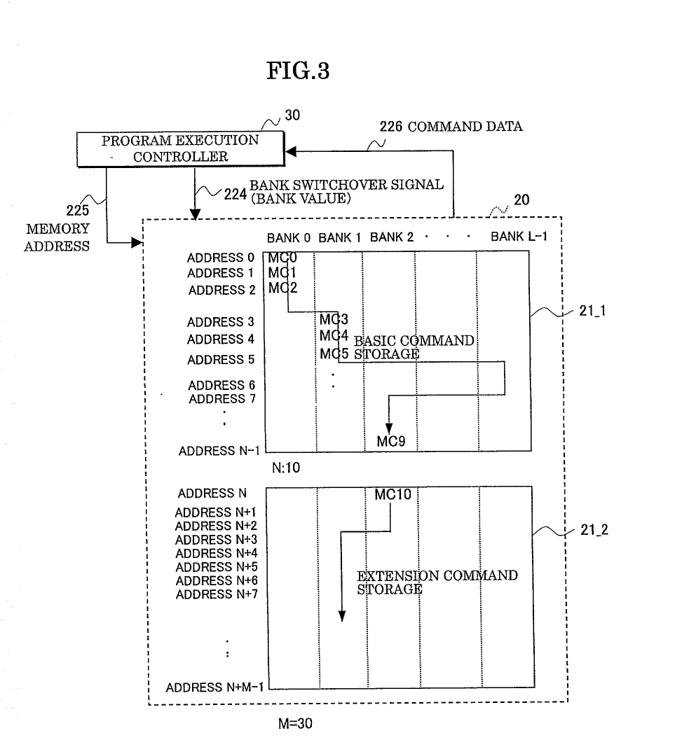

FIG. 3 shows a control example for executing the program stored in the execution program holder 20 shown in FIG. 2. In this holder 20, the extended command storages 21_3 and 21_4 shown in FIG. 2 are omitted for the sake of simplifying the figure.

In FIG. 3, the command number N=“10” in the basic command storage 21_1, and the command number M=“30” in the extension command storage 21_2.

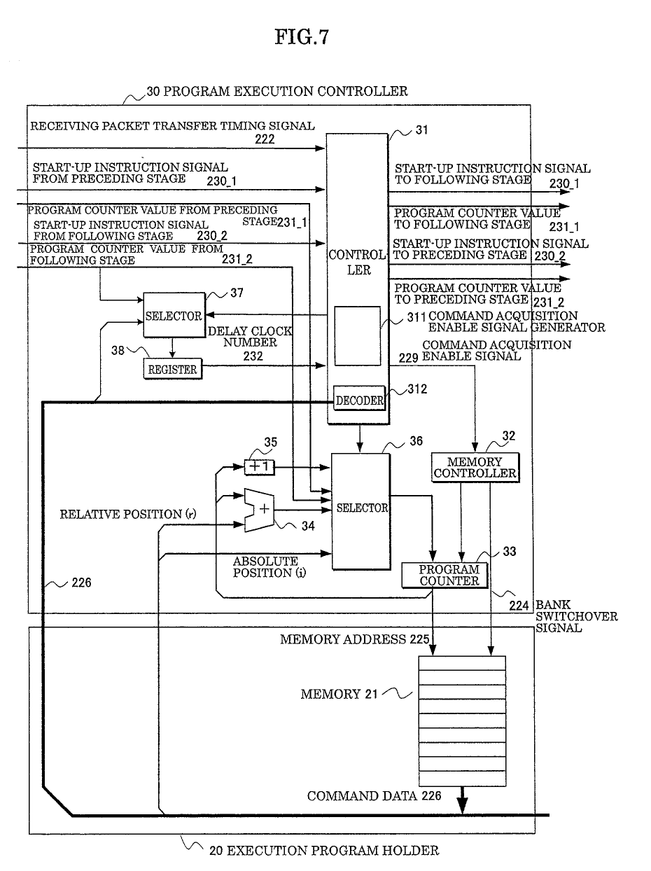

The program execution controller 30, as shown in FIG. 7 described later, includes the program counter 33 and the +1 adder 35 which are the same as those shown in FIG. 14.

Being triggered by receiving the receiving packet transfer timing signal 222, the controller 30 provides as outputs the bank switchover signal 224=“bank 0” and the memory address 225=“address 0” to the execution program holder 20, and acquires as an input the head command=“microcode MC0” in the basic command storage 21_1 by command data 226.

Then, the controller 30 repeats the operation of incrementing the program counter 33 (not shown) by “1” and acquiring the next command up to the final command stored in the basic command storage 21_1. The controller 30 executes only the program control command such as a bank switchover. The command executing unit 40 executes other commands.

When the acquired command is a bank switchover command, the program execution controller 30 provides the bank value designated by the operand of the bank switchover command to the holder 20 by the bank switchover signal 224 to execute the switchover. This bank value is held until the value is changed by the next bank switchover command or a new receiving packet transfer timing signal 222 is inputted.

After the processing of the command stored in the basic command storage 21_1 is finished, the program execution controller 30 determines whether or not the extension command storage 21_2 is executed according to an allowable command number obtained by the request throughput, the command execution clock rate, the data transfer width of the packet data holder 70, the transfer clock rate, and the target packet length (minimum value), and the executable command number obtained by the receiving packet length signal 223 from the packet data input unit 60.

When the request throughput is 2.5 Gbps, the data transfer width of the packet data holder 70 and the transfer clock rate are respectively 32 bits and 100 MHz, and the command execution rate is also 100 MHz, the allowable command number for a 40 bytes packet assumes “12”.

Also, supposing that N=“12” in the basic command storage 21_1, and M=“36” in the extension command storage 21_2, the executable and command number is “24” when the packet length=80 bytes indicated by the receiving packet length signal 223 from the packet data input unit 60, so that “12” commands of the extension command storage become executable.

Furthermore, when the packet length is 160 bytes, the executable command number=“48”. Therefore, “36” commands of the extension command storage 21_2 become executable.

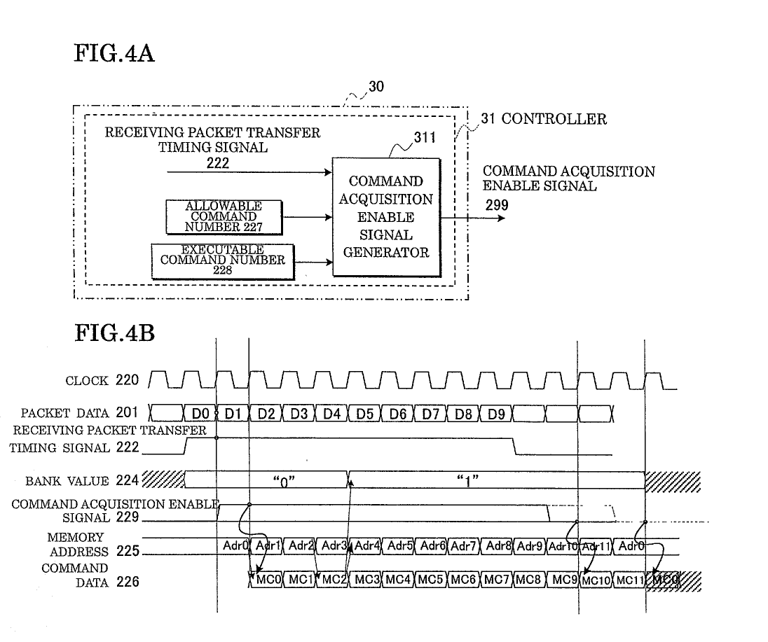

FIG. 4A shows a command acquisition enable signal generator 311 included in the program execution controller 30. This generator 311 generates a command acquisition enable signal 229 based on the receiving packet transfer timing signal 222, an allowable command number 227, and an executable command number 228 obtained from the received packet length.

The allowable command number 227 is set to “12”. The command acquisition enable signal generator 311 outputs the command acquisition enable signal 229 of the clock number according to the executable command number 228, so that whether or not the extension command storage 21_2 is executed is determined.

FIG. 4B shows a timing example and a bank switchover example when the program execution controller 30 and the command executing unit 40 change the command number to be executed based on the command acquisition enable signal 229.

A clock 220 serves as a command execution clock and a transfer clock, so that the program execution controller 30 and the command executing unit 40 operate in synchronization with the clock 220. Being triggered by the rise of the receiving packet transfer timing signal 222, the registers p9-p0 (see FIG. 2) synchronize data D0-D9 of the packet 201 with the clock 220 to be sequentially transferred (shifted).

The controller 30 outputs the memory address 225=“memory address 0” and the memory bank switchover signal 224=“bank 0”.

The program execution controller 30 and the command executing unit 40 execute the microcode MC0 stored in a “memory address Adr0” and the “bank 0”. Hereafter, the microcodes MC1 and MC2 are executed in the same way.

When the microcode MC2 is a conditional branch command (bank switchover command), the controller 30 outputs the memory address 225=“address Adr4” and the memory bank switchover signal 224=“bank 1” according to the condition to acquire the microcode MC4.

It is to be noted that when the condition does not require the bank switchover, the controller 30 does not change the memory bank switchover signal 224=“bank 0” but outputs the memory address 225=“address Adr4” to acquire the microcode “address Adr4” of the “bank 0” and the following microcodes (see FIG. 3).

Hereafter, the command executing unit 40 sequentially executes the branched commands MC4, MC5, . . . . Then, the controller 30 executes the designated bank switchover every time the bank switchover is commanded, and the command executing unit 40 executes the command selected by the bank switchover in the same way.

All of the microcodes MC0-MC9 set in the basic command storage 21_1 are executed. When the command acquisition enable signal 229, as shown by dashed lines, further indicates “command acquisition enable”, for example, the processing from the microcode MC10 to the microcode MC11 after a single clock from the fall of the command acquisition enable signal 229 is sequentially executed.

Namely, when the executable command number is equal to or less than the allowable command number, the program execution controller 30 executes only the basic command storage 21_1 to end the command, otherwise further executes the (executable command number—allowable command number) commands of the extension command storage 21_2.

Thus, the processor 101 of the present invention changes the command number which the program execution controller 30 executes according to the receiving packet length signal 223 and the processing contents of the program, thereby enabling the executable command number to be increased. Also, this enables the access to the data located in a rearward position in the packet.

While the executable command number is changed by the command acquisition enable signal 229 in FIGS. 4A and 4B, the executable command number 228 can be changed by e.g. describing the command for rewriting the allowable command number 227 in the program within the basic command storage 21_1.

Hereinafter, this will be described in the case where the packet 201 including the IPv6 header is processed.

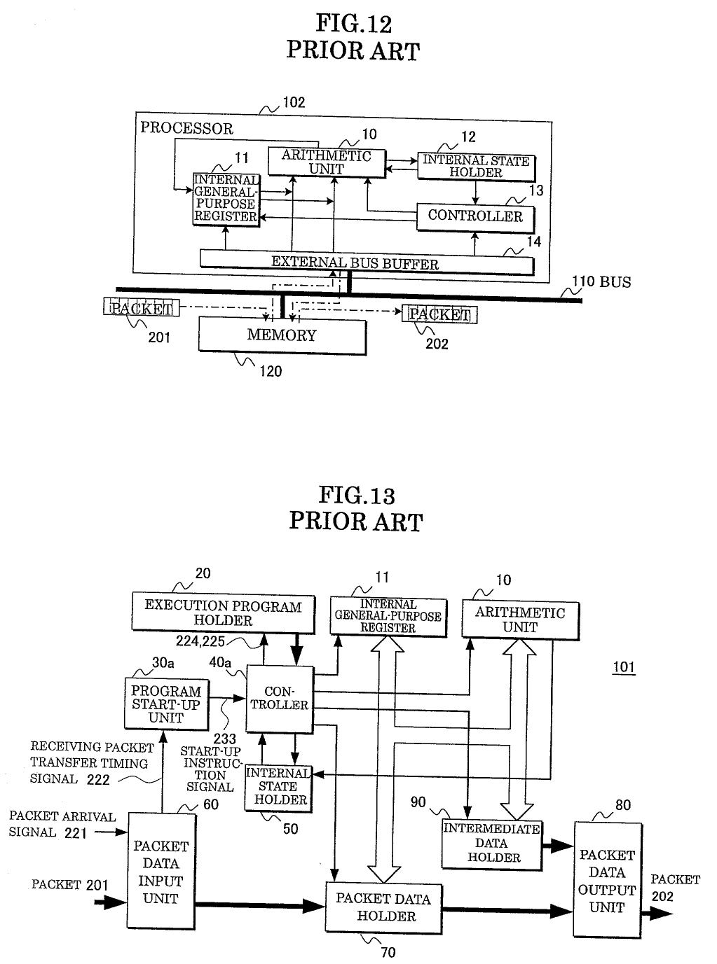

As shown in FIG. 12, the length of the IPv6 basic header of the packet 201 is fixed 40 bytes. Accordingly, supposing that the width of the registers p0-p9=“32 bits”, τ=“transfer clock width”=“command execution clock width”, the packet processing for 10 τ commands (i.e. 10 commands; this number is equivalent to the executable command number by the command stored in the basic command storage 21_1) is enabled in the IPv6 basic header.

After the packet processing of the IPv6 basic header and all of the commands stored in the basic command storage 21_1 are executed, the headers of the IPv6 extension header or the upper layer (TCP/UDP, etc.) follow the basic header.

In order to determine which header of these headers follows, preliminarily the processing of the IPv6 basic header is described in the basic command storage 21_1, and the value of the “next header field” is extracted, so that the commands stored in e.g. the general-purpose register 11 (see FIG. 1) are described.

According to this method, it is not necessary to determine whether or not the processing for the extension header is executed by the program (command) in the basic command storage 21_1. The programming has only to be performed in the extension command storage 21_1 based on the premise that the value of the next header field is set in the above-mentioned general-purpose register 11.

As a programming example, the packet processing programs corresponding to the IPv6 extension header, the TCP header, and the UDP header are respectively stored in the banks 0-2 of the extension command storage 21_2.

The program execution controller 30 has only to determine whether or not the IPv6 extension header, the TCP header, or the UDP header follows based on the value of the “next header field” stored in the general-purpose register 11 to select the packet processing program corresponding to the determined header by the bank switchover to be acquired.

As described above, the overhead of the processing in the programming is suppressed, and the mounting of optional processing becomes possible with a predetermined throughput being maintained.

[2-1] Embodiment (1) of Packet Processor System

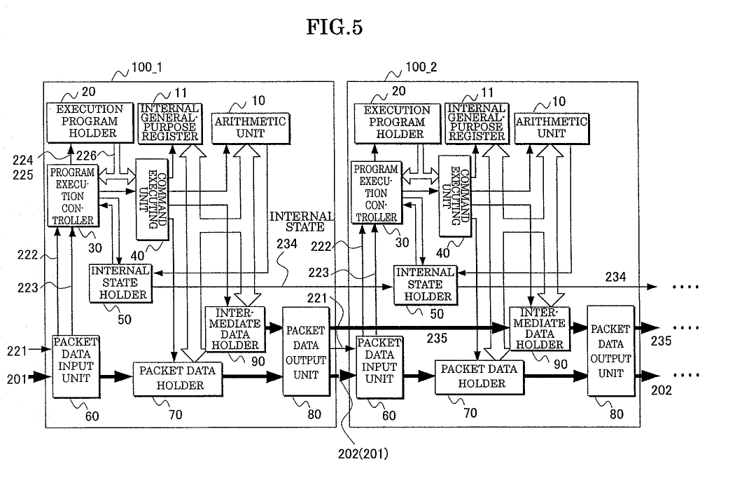

FIG. 5 shows an embodiment (1) of a packet processor system according to the present invention, in which the packet processors 100_1, 100_2, . . . (hereinafter, occasionally represented by a reference numeral 100) shown in FIG. 1 are connected in series to compose a packet processor system.

The internal state 234 of the program execution controller 30 in each packet processor 100 is held in the internal state holder 50 to be taken over to the packet processor 100 at a preceding stage.

The internal state 234 comprises an allowable command number, an executable command number, and a bank value. It is to be noted that the allowable command number and the executable command number are not taken over by the internal state, but the result determined according to the algorithm described in the embodiment [1] indicates whether or not the next command is acquired. Therefore, the allowable command number and the executable command number may be passed over as intermediate data 235 from the packet processor 100 to the packet processor 100 at the preceding stage in synchronization with the packet 201 (202).

Also, the allowable command number and the executable command number to be passed over from the packet processor at the present stage to the packet processor 100 at the preceding stage may be set by the program within the packet processor 100 at the preceding stage.

According to the packet processor system of the present invention, it becomes possible to increase the executable command number and enlarge the accessible range for the packets 201 in each of the packet processor 100, and also to increase the executable command number and enlarge the accessible range as the whole system.

Thus, it becomes possible to reduce the stage number of the packet processor system.

[2-2] Embodiment (2) of Packet Processor System

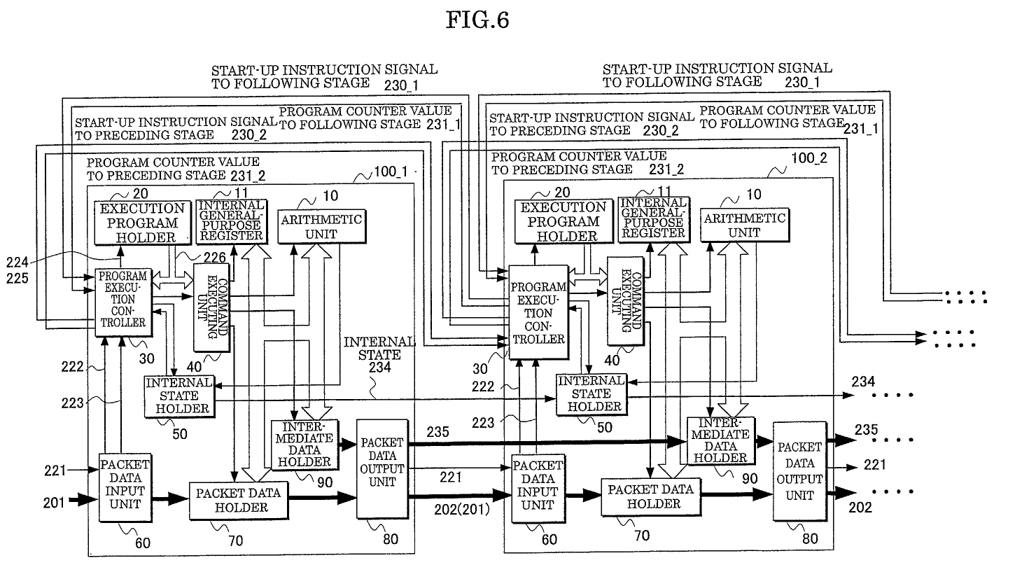

FIG. 6 shows an embodiment (2) of the packet processor system according to the present invention. In this system, in the same way as the system of the embodiment (1) shown in FIG. 5, a plurality of packet processors 100_1, 100_2, (hereinafter, occasionally represented by a reference numeral 100) are connected in series.

The system of the embodiment (2) is different from that of the embodiment (1) in that each of the packet processors 100 provides a “start-up instruction signal 230_1” and a “program counter value 231_1” to the processor 100 at the following stage, and provides a “start-up instruction signal 230_2” and a “program counter value 231_2” to the processor 100 at the preceding stage.

It is to be noted that the packet processor 100_1 at the last stage has no following processor 100, and only provides the “start-up instruction signal 230_2” and the “program counter value 231_2” to the processor 100 at the preceding stage. Similarly, the first packet processor 100 only provides the “start-up instruction signal 230_1” and the “program counter value 231_1” to the processor 100 at the following stage.

FIG. 7 shows an arrangement of the execution program holder 20 and the program execution controller 30 of each packet processor 100 in the system of the embodiment (2). The arrangement of the holder 20 is the same as that shown in FIG. 2 and is provided with the memory 21 storing the microcode.

The program execution controller 30 is composed of a controller 31, a memory controller 32, the program counter 33, the adder 34, the +1 adder 35, selectors 36 and 37, and a register 38.

The controller 31 is provided with the command acquisition enable signal generator 311 and the decoder 312, for inputting the timing signal 222, the start-up instruction signal 230_1 from the preceding stage, the start-up instruction signal 230_2 from the following signal, a delay clock number 232, and the command data 226, and for outputting the start-up instruction signal 230_1 to the following stage, the program counter value 232_1 to the following stage, the start-up instruction signal 230_2 to the preceding stage, the program counter value 231_2 to the preceding stage, and the command acquisition enable signal 229.

The memory controller 32 inputs the command acquisition enable signal 229 and outputs the signal for controlling the bank switchover signal 224 and the program counter 33. The program counter 33 outputs the memory address 225.

When the start-up instruction signal 230_1, the start-up instruction signal 230_2, or the timing signal 222 is inputted, the controller 31 provides a signal for instructing to select the “predetermined initial value”, the “counter value 231_1” or the “counter value 231_2” as the next value of the program counter 33 to the selector 36.

When neither of the start-up instruction signals 230_1, 230_2, nor the timing signal 222 is inputted, the controller 31 decodes the command data 226 within the memory 21 designated by the memory address 225 and the bank switchover signal 224, and determines to select, as the next value of the program counter 33, any one of the “value, obtained by incrementing the value of the program counter 33 by “1” at the +1 adder”, the “absolute position designated by the operand of the command data 226”, and the “relative position designated by the operand of the command data 226”.

In the prior art packet processor system shown in FIG. 15, the packet processor 101 after executing a predetermined command number starts the processing only with the next packet arrival signal 221.

As a result, when a certain packet 201 receives attention in a plurality of packet processors 101 sequentially started-up for the packet 201 shifting within the packet data holder 70, the packet processors 101 at the preceding and the following stages are in the stop state for the packet processor 101 driven at present.

Accordingly, it is impossible to describe the processing spanning the packet processors 101 and to continue the processing repeatedly.

In order to solve this problem, the program execution controller 30 of the packet processor 100 in the packet processor system of the embodiment (2) enables the start-up instructions from the packet processors 100 at the preceding and the following stages in addition to the start-up instructions by the general receiving packet transfer timing signal 222 which immediately starts the command acquisition from the execution program holder 20.

Namely, in case of the start-up instructions by the receiving packet transfer timing signal 222, the controller 30 starts the command acquisition from the head position of the basic command storage 21_1. When the start-up instruction signals 230_1 and 230_2 are received from the packet processors 100 at the preceding and the following stages, the command acquisition is started from the position of the program counter values 231_1 and the 231_2 provided with the signals.

The controller 30 decodes the acquired command data 226 at the decoder 312, and determines the processing only relating to the program control command such as a bank switchover. The processing of other command data 226 is determined by the command executing unit 40 (see FIG. 6).

Namely, if the command data 226 are not the program control command, the controller 30 outputs the acquired command data 226 to the command executing unit 40, and increments the program counter 33 by “1” to acquire the next command data 226.

Also, if the acquired command data 226 are the bank switchover commands, the controller 30 acquires, according to the operand (bank value) designated by the command, the next command data from the bank. This bank value is held until the value is changed by the command or a new packet is inputted.

The command data 226 can designate an increment value (j) of the program counter 33. When the command data 226 are acquired in which a positive or a negative increment value “j” is designated, the controller 30 determines whether or not the branch spans the packet processors 100 from the inclement value (j), an arrangement position (i) of the command, and the stored command number (N) of the packet processor.

When the branch does not span the packet processors 100, the controller 30 updates the program counter 33 with a value in which the increment value (j) including the designated positive or negative sign and the present counter value of the program counter 33 are added, so that the next command data 226 are acquired.

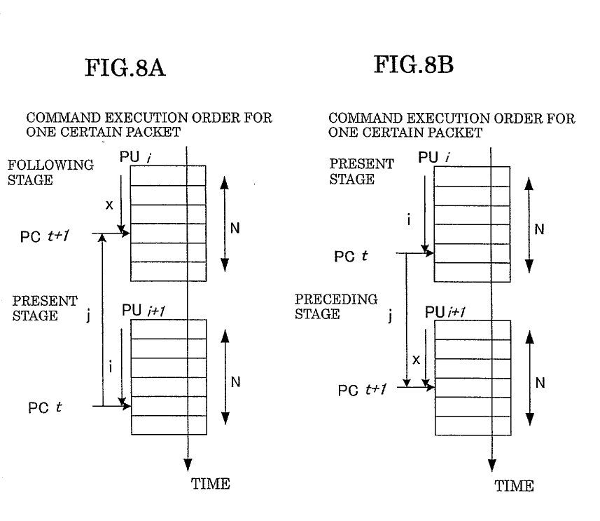

FIGS. 8A and 8B show an example of the command execution order based on the branch command. FIG. 8A shows an example of a backward branch. In the processor at the present stage, the command data at the arrangement position “i” indicate a negative increment value “j”. FIG. 8B shows an example of a forward branch. In the processor at the present stage, the command data at the arrangement position “i” indicate a positive increment value “j”.

When the branch spans the packet processors 100 and the negative inclement value “j” is designated, the controller 30 outputs the start-up instruction signal 230_1 and the program counter value 231_1 to the packet processor 100 at the following stage.

The program counter value 231_1 (=“x”) transmitted to the packet processor 100 at the following stage is obtained from the designated increment value “j”, the arrangement portion “i” of this command, and the executable command number N of the packet processor 100 (see FIG. 8A).

When the branch spans the packet processors 100 and the positive increment value “j” is designated, the controller 30 outputs the start-up instruction signal 230_2 and the program counter value 231_2 to the packet processor 100 at the preceding stage.

The program counter value 231_2 (=“x”) transmitted to the packet processor at the preceding stage is obtained from the designated increment value “j”, the arrangement portion “i” of this command, and the executable command number N of the packet processor (see FIG. 8B).

It is to be noted that the packet processor 100 at the preceding stage uses the program counter value 231_2 as a delay time until the program acquisition start.

The procedure by which the controller 30 obtains the program counter values 231_1 and 231_2 will be described referring to FIGS. 8A and 8B.

(1) If the increment value “j” designated by the command is negative, the controller 30 compares “i” with “j” (absolute values) (see FIG. 8A).

(1-1) When i<j, the controller 30 determines that the branch spans the packet processors 100, and outputs the start-up instruction signal 230_1, and the program counter value 231_1=“x”=“N−(j−i)” to the packet processor 100 at the following stage.

(1-2) When i>j, the controller 30 determines that the branch does not span the packet processors 100, and subtracts “j” from the present program counter value “i” to make the new program counter value=“i−j”.

(2) If the increment value “j” designated by the command is positive, the controller 30 compares “i+j” with N (see FIG. 8B).

(2-1) When i+j>N, the controller 30 determines that the branch spans the packet processors 100, and outputs the start-up instruction signal 230_2, and the program counter value 231_2=“x”=“i+j−N” to the packet processor 100 at the preceding stage.

(2-2) When i+j<N, the controller 30 determines that the branch does not span the packet processors 100, and adds “j” to the present program counter value “i” to make a new program counter value=“i+j”.

The controller 30 repeats the above-mentioned branch procedure until the command of the final address of the program in the command storage is acquired.

When recognizing the receiving packet transfer timing signal 222, the controller 30 basically starts the execution from the head of the basic command storage 21_1 in the same way as the embodiment of FIG. 1 as mentioned above. However, when the start-up instruction signal 230_1 is received from the packet processor 100 at the preceding stage, the controller 30 acquires the command of the address of the program counter value 231_1 provided simultaneously with the start-up instruction signal 230_1.

On the other hand, when receiving the start-up instruction signal 230_2 from the packet processor 100 at the following stage, the controller 30 recognizes the input of the receiving packet transfer timing signal 222, and acquires the command of the address of the program counter value 231_2 after a delay time for the same command execution clocks as the program counter value 231_2 provided simultaneously with the start-up instruction signal 230_2.

Thus, it becomes possible for the packet processor system of the present invention to execute the branch command spanning the packet processors 100.

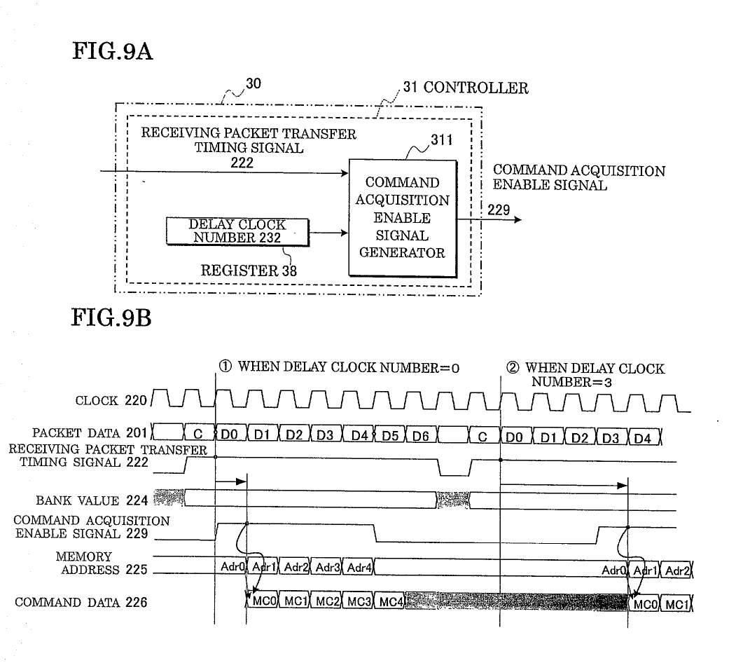

FIGS. 9A and 9B show a timing example of the command execution when the program execution controller 30 receives the start-up instruction signal 230_2 from the packet processor 100 at the following stage. The controller 30 is provided with the controller 31 as shown in FIG. 7, which includes the command acquisition enable signal generator 311.

FIG. 9A shows the generator 311, which inputs the receiving packet transfer timing signal 222 and the delay clock number 232 from the register 38 (see FIG. 7), and outputs the command acquisition enable signal 229.

The controller 30 is composed so that the program counter value 231_2 from the packet processor 100 at the following stage may be set in the register 38 as the delay clock number (command execution clock number) 232. Namely, as shown in FIG. 7, the controller 30 is composed so that the program counter value 231_2 may be stored in the register 38 through the selector 37.

In FIG. 9B, a timing \mathring{1} indicates the case where the delay clock number−“0”, and a timing \mathring{2} indicates the case where the delay clock number=“3”.

It is to be noted that the generator 311 synchronizes with the clock 220.

At the timing \mathring{1}, the generator 311 makes the command acquisition enable signal 229 “active” with 1 clock being delayed from the rise of the receiving packet transfer timing signal 222. As a result, the memory address 225=“Adr0” is outputted, and the command data 226=“microcode MC0” is outputted with 1 clock being delayed.

Hereafter, the memory addresses 225=“Adr1”, . . . , “Adr4” are sequentially outputted, and corresponding command data 226=“MC1”, . . . , “MC4” are outputted with 1 clock being delayed in the same way.

At the timing \mathring{2}, the generator 311 makes the command acquisition enable signal 229 “active” in synchronization with the rise of the clock 220 which is further delayed by “delay clock number”=“3” clocks stored in the register 38 from the rise of the clock 220 which is delayed by one clock from the rise of the receiving packet transfer timing signal 222.

As a result, the memory addresses 225=“Adr0”, “Adr1”, . . . are sequentially outputted, so that the corresponding command data 226=“MC0”, “MC1”, . . . are outputted with only 1 clock being delayed.

Thus, it becomes possible to provide a section where a command is not executed for predetermined command execution clocks after the receiving packet transfer timing signal 222.

It is to be noted that when the time for a required transfer clock number obtained from the data transfer width, the transfer clock rate, and the receiving packet length of the packet data holder 70 has elapsed after the input of the packet head, the controller 30 ends the acquisition of the next command and waits for the receiving packet transfer timing signal 222 (i.e. the input of the next packet) or the start-up instruction signal 230_1 or 230_2.

Thus, a malfunction can be avoided so that useless packet processing is performed although a packet in processing does not exist in the packet data holder 70 of a single processor 100.

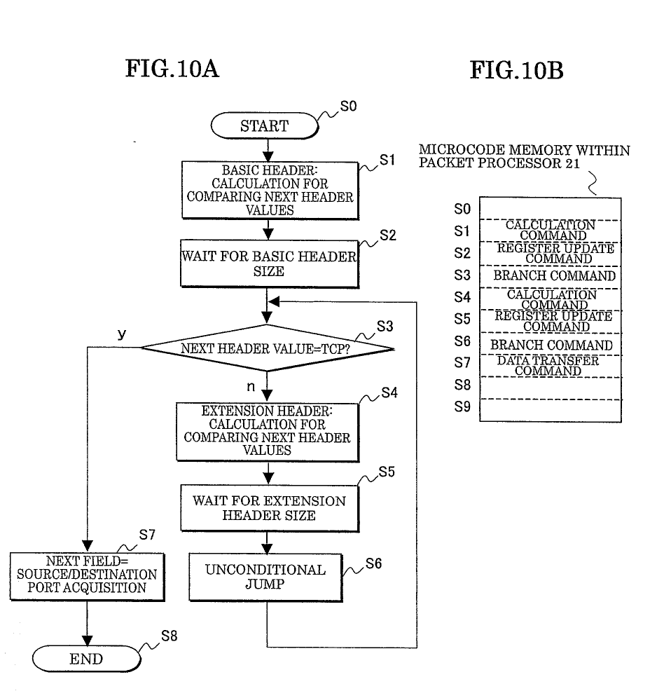

FIG. 10A shows an algorithm example by which repeat processing is performed in the same packet processor 100. In this algorithm example, considering that an arbitrary length extension header is assigned in the IPv6 packet, an upper protocol TCP source/destination port No is acquired.

In order to simplify the description, the command execution clock rate is supposed to be twice as fast as the transfer clock rate of the packet 201 in the packet holder 70, and the register p0-p9 width within the packet data holder 70 is supposed to be 32 bits.

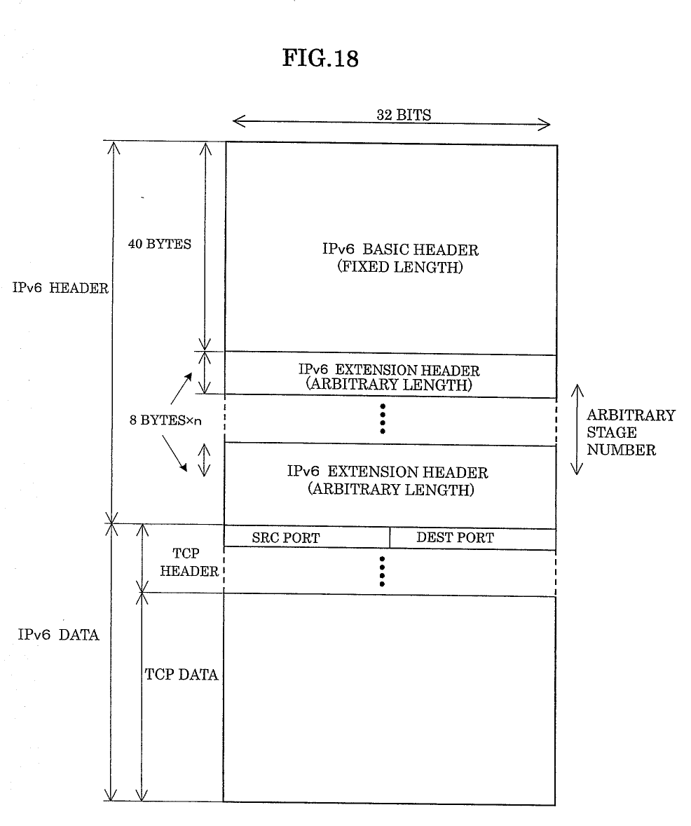

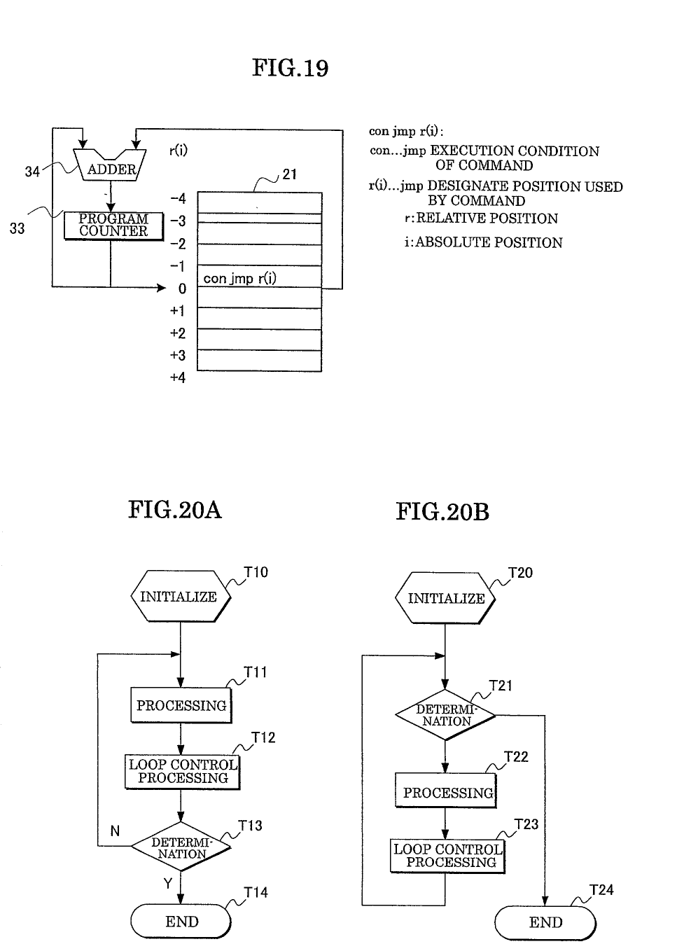

As shown in FIG. 18, the IPv6 header has a composition in which various extension headers having the length of integral multiple of 8 bytes are chained to the fixed length (40 bytes) basic header.

Accordingly, in order to acquire the upper protocol UDP/TCP source/destination port No. from the IPv6 packet, the controller 30 is required to sequentially repeat the processing of determining whether the extension header follows or the upper protocol follows by a “type value” set to the “next header field” in the basic header or the extension header, with the “next header field” in the basic header being made a base point, and of acquiring the next header field by the value of the “header extension length field”.

It is to be noted that the “header type value” inserted into the “next header field” is determined by the RFC1700. In case of the TCP, for example, the header type value is “6 (Decimal)”, and in case of the UDP, the header type value is “17 (Decimal)”. Accordingly, when the value of the “next header field”=“6” or “17”, the controller 30 can determine that the header of the upper TCP or UDP packet comes next.

While each of the packet processors 100 sequentially executes the command by the command execution clock, the data of the object packet 201 are sequentially transferred within the packet data access registers p0-p9 of the packet data holder 70 by the transfer clock. In consideration of the fact, the controller 30 is required to extract the next header of the IPv6 extension header and the next header extension length field.

This extraction is performed by an arithmetic command which makes an operand “the reference position (e.g. register p9) of the packet data access registers p0-p9”.

Similarly, the “source/destination port No. field” of the TCP header is transferred to the “transferring destination register” by the data transfer command which makes an operand the “reference position of the registers p0-p9” and the “transferring destination register name”.

In order to repeatedly execute the arithmetic command and the data transfer command by the algorithm, the reference position (register p9) described as an operand is fixed.

Accordingly, the program is required to be composed so that the timing may be adjusted before the execution of the arithmetic command and the data transfer command in order that the object field “next header field” and the “header extension length field” within the extension header, or “source/destination port No. field” of the TCP header may exist at the reference position within the registers p0-p9 at the timing when the arithmetic command and the data transfer command are executed.

Also, the packet processor 100 executes the register update command which makes operand the “register 38” and the “arbitrary delay clock number”, thereby enabling the register 38 to be updated by the “arbitrary delay clock number”. Namely, as shown in FIG. 7, the operand (delay clock number) of the command data 226 (=register update command) is stored in the register 38 through the selector 37.

When the register update command in which the “register 38” and the “delay clock number” are set in the operand is executed, the next command of the register update command is executed after stopping the execution of the “delay clock number” commands.

After executing the register update command, the controller 30 has only to increment the program counter 33 (see FIG. 7) by “1” and to wait for the next command acquisition start.

Thus, it becomes possible to stop the command execution for an arbitrary command execution clock.

FIG. 10B shows an example of the command arrangement on the program memory 21. Hereinafter, the algorithm and the command will be described referring to FIGS. 10A and 10B. It is to be noted that the above-mentioned reference position is supposed to be the register p9.

Step S1: The command executing unit 40 compares the next header field value of the basic header within the packet data access register with the “6 (Decimal)” indicating the TCP value by the arithmetic command, and sets the result in the internal state (flag).

Step S2: The register update command updates the register 38 by the “delay clock number”, defers the data of the packet 201 within the registers p0-p9 by “delay clock number”, and performs an adjustment so that the “next header field” of the IPv6 header may come to the register p9 to be accessed at step S4. The “delay clock number” referred heretofore is a value=“16” fixedly obtained from the size of the IPv6 basic header.

Step S3: The process branches according to the flag state of the arithmetic result at step S1 or step S4. When the flags are coincident with each other, the process proceeds to step S7, otherwise proceeds to next step S4.

Step S4: The arithmetic command compares the value of the “next header field” of the extension header within the register p9 with the “6 (Decimal)” indicating the TCP, and sets the result in the flag.

Step S5: The register update command updates the register 38 by the “delay clock number”, and defers the data of the packet 201 within the packet data access registers p0-p9 by the “delay clock number”.

The “delay clock number” referred heretofore is a variable value obtained from the “header length field” of the extension header. For example, the value is “0” in case the header length=“8”, and the value is “4” in case the header length=“16”. As a result, the wait is to be performed for the extension header size.

Step S6: By the unconditional brunch command, the process jumps to step S3.

Step S7: By the data transfer command, the “source/destination port No.” of the TCP header is transferred to the designated register.

Thus, the “source/destination port No.” is acquired.

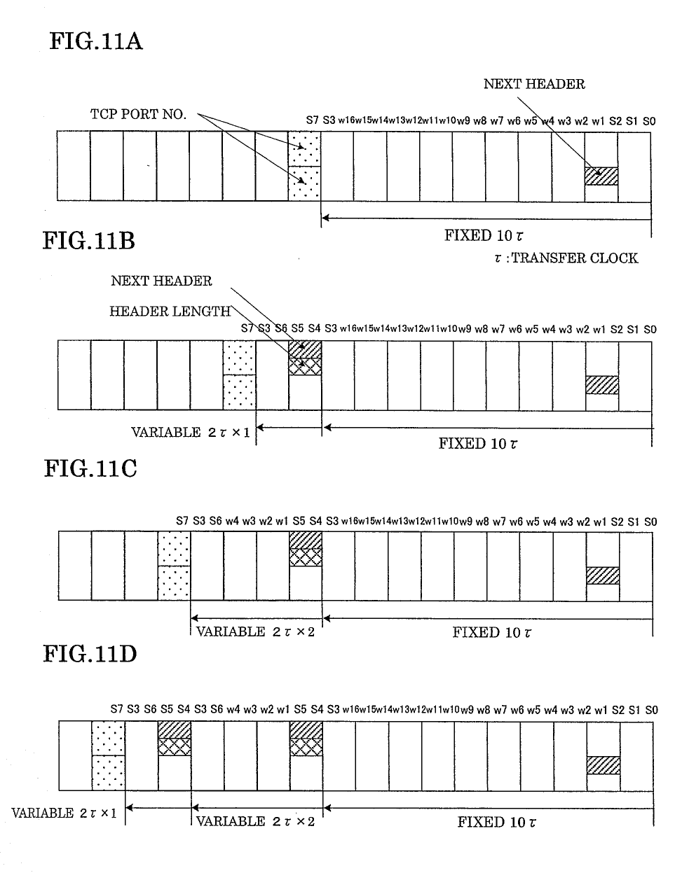

FIGS. 11A-11D show examples of operation steps obtaining, according to the algorithm shown in FIG. 10A, the source/destination port No. of the TCP packet included in the IPv6 packet.

FIGS. 11A-11D respectively show cases where the IPv6 header is only the basic header, the basic header+8 bytes extension header, the basic header+16 bytes extension header, and the basic header+16 bytes extension header+8 bytes extension header.

The reference numerals S0-S7, and w1-w16 in FIGS. 11A-11D respectively indicate the step Nos. (step Nos. S0-S9 in FIG. 10A) of the program executed when the fields of the packet are stored in the first register p9 (see FIG. 2) of the packet data access register, and the waiting states.

Hereinafter, an operation example of FIG. 11D will be described.

<Basic header>:

Step S1: The value of the “next header field” of the basic header is compared with a predetermined value by the arithmetic command, so that it is confirmed that the extension header follows.

Step S2: By the register update command, the waiting states w1-w16 for the fixed length of the basic header are inserted.

Step S3: Since it is confirmed that the next header is not a TCP header at step S1, the process proceeds to step S4 by the branch command.

<The first extension header>:

Steps S4 and S5: It is confirmed that the next header is the extension header by the arithmetic command, and the waiting states w1-w4 are inserted based on the value of the header length field by the register update command.

Step S6: By the unconditional branch command, the process returns to step S3.

Step S3: Since it is confirmed that the next header is not a TCP header at step S4, the process proceeds to step S4 by the branch command.

<The second extension header>:

Steps S4 and S5: It is confirmed that the next header is a TCP header by the arithmetic command, so that the process proceeds to step S6 without inserting the waiting states based on the value of the header length field by the register update command.

Step S6: By the unconditional branch command, the process returns to step S3.

Step S3: Since it is confirmed that the next header is a TCP header at step S4, the process proceeds to step S7 by the branch command.

<TCP header>:

Step S7: The “source/destination port No.” is stored in a predetermined register by the data transfer command.

Similarly, in the operation examples of FIGS. 11A-11C, the source/destination port No. of the TCP header can be recognized by the execution of the command of the step No. shown in the operation examples and the insertion of the waiting state based on the command.

Namely, the program shown in FIG. 10B indicates that it is possible to extract the source/destination port No. of the upper TCP header included in the IPv6 packet having various types of headers.

In the algorithm example including the branch command shown in FIGS. 10A and 10B, and FIGS. 11A-11D, only the branch within the same packet processor 100 has been described above. Namely, it has been described above that the branch within the same packet processor 100 is possible.

When the executable command number=“5” in a single packet processor 100 because of the high-speed request throughput, for example, the microcodes of steps S0-S7 shown in FIG. 10B have to be dispersedly arranged in the memories 21 of a plurality of packet processors 100.

Therefore, the microcodes of steps S0-S4 are arranged in the memory 21 of the packet processor 100 at the following stage shown in FIG. 8A, and the microcodes of steps S5-S7 are arranged in the memory 21 at the present stage. If this shown in FIG. 8B, the microcodes of steps S0-S4 are arranged in the memory 21 at the present stage, and the microcodes of steps S5-S7 are arranged in the memory 21 at the preceding stage.

While the branch to step S3 by the unconditional branch command (see FIG. 10A) at step S6 corresponds to the backward branch shown in FIG. 8A, the branch to step S7 by the conditional branch command at step S3 corresponds to the forward branch shown in FIG. 8B.

When acquiring the branch command, the program execution controller 30 (see FIG. 7) of the packet processor 100 at each stage has only to execute the branch command by the procedure shown in FIGS. 8A and 8B, and transmit the start-up instruction signal and the program counter value to the program execution controller 30 of the corresponding packet processor 100.

As described above, in the prior art packet processor system, it was possible to describe the processing of a fixed range from the packet head, namely, only the packet data transferred within the packet data holder in the command execution time of the allowable command number. However, in the packet processor system of the present invention, it becomes possible to describe branch processing and repeat processing as long as the object packet is transferred within the packet data holder 70.

It is to be noted that in the above-mentioned embodiments of the present invention, the packet processing for the packet of the TCP/IP protocol has been described. However, the packet processor and the packet processor system of the present invention can be applied to the processing of other protocols, other hierarchy packets (cell, datagram, frame), or the like.

For example, by the same operation as the operation example shown in FIGS. 11A-11D, the packet processor system of the present invention can describe the extraction processing of data such as an FCS (Frame Check Sequence) at the end of the packet and the checksum, and the processing extending over whole of the packet.

It is to be noted that in the above-mentioned embodiments of the processor and the processor system, it is arranged that the substance of the packet data shifts within the packet access register. However, what is actually stored in the packet data access register is not limited to the substance of the packet data, but may be data extracted from the packet data for the recomposition.

Furthermore, as described in “Packet data processing apparatus” of Japanese Patent Application No. 12-240829, if the total stage number of the packet data holder 70 in each packet processor 100 within the packet processor system is sufficiently larger than the maximum length of the processed packet, the above-mentioned processing result can be used at the packet processor at the preceding stage by combining information communicating mechanisms between the FIFO (First-In-First-Out) type of packet processors 100.

As described above, a packet processor and a packet processor system according to the present invention is arranged such that a packet register sequentially receives a packet from its head; an execution program holder holds a program in which a processing procedure of the packet is described; and a program execution controller determines a command number of a program to be executed based on a provided packet length and the program, and controls an execution of the program. Therefore, it becomes possible to increase an executable command number and to enlarge an accessible packet range.

Especially in the packet processor system, since the executable command number and the accessible range for a single packet as the whole system can be increased, a stage number in the system can be decreased. As a result, hardware resources can be effectively used.

Also, the program execution controller instructs the program execution controller of at least one of the packet processors at a preceding stage and a following stage of a command acquisition timing and a command acquisition position. Thus, it becomes possible to describe and execute a branch command of a program spanning the packet processors, and to flexibly perform programming of packet processing.

Also, it becomes possible for the program execution controller not to perform a command acquisition for a predetermined command execution clock, not to perform a command acquisition for predetermined command execution clocks after receiving a transfer timing signal, and to flexibly describe a packet processing program.

Thus, the present invention enables a command execution delay mechanism within the packet processors, a branch command within the same bank, and a mutual start-up control between the packet processors, thereby enabling the programming of the packet processing to be flexibly performed.

What we claim is:

1. A packet processor comprising:
a packet register for sequentially receiving a packet from its head;
an execution program holder for holding a program in which a processing procedure of the packet is described; and
a program execution controller for determining a command number of a program to be executed based on a provided packet length and the program, and for controlling an execution of the program.

2. A packet processor system comprising:
at least two packet processors connected in cascade;
each of the processors including; a packet register for sequentially receiving a packet from its head;
an execution program holder for holding a program in which a processing procedure of the packet is described;
a program execution controller for determining a command number to be executed based on a provided packet length and the program, and for controlling an execution of the program; and
an internal state holder for holding an internal state;
the internal state of the packet processor at a present stage and an output packet being provided to the packet processor at a preceding stage.

3. A packet processor system comprising:
at least two packet processors connected in cascade so that an output packet of the packet processor at a present stage is provided to the packet processor at a preceding stage;
each of the processors including; a packet register for sequentially receiving a packet from its head;
an execution program holder for holding a program in which a processing procedure of the packet is described; and
a program execution controller for controlling an execution of the program;
the program execution controller of the packet processor at the present stage instructing the program execution controller of at least one of the packet processors at the preceding stage and a following stage of a command acquisition timing and a command acquisition position.

4. The packet processor system as claimed in claim 3 wherein the program execution controller determines a command number of a program to be executed based on a provided packet length and the program.

5. The packet processor system as claimed in claim 3 wherein the packet processor further includes an internal state holder for holding an internal state, and
the internal state of the packet processor at the present stage is provided to the packet processor at the preceding stage.

6. The packet processor system as claimed in claim 2 wherein the execution program holder is capable of switching over a bank, and the internal state comprises a bank value.

7. The packet processor as claimed in claim 1 wherein by a finish of a packet in processing or an input of a new packet, the program execution controller stops acquiring a next command for the packet.

8. The packet processor system as claimed in claim 2 wherein by a finish of a packet in processing or an input of a new packet, the program execution controller stops acquiring a next command for the packet.

9. The packet processor as claimed in claim 1 wherein the program execution controller does not execute a command acquisition for predetermined command execution clocks.

10. The packet processor system as claimed in claim 2 wherein the program execution controller does not execute a command acquisition for predetermined command execution clocks.

11. The packet processor as claimed in claim 1 wherein the program execution controller does not execute a command acquisition for predetermined command execution clocks after a transfer timing signal indicating a timing when the packet is inputted is received.

12. The packet processor system as claimed in claim 2 wherein the program execution controller does not execute a command acquisition for predetermined command execution clocks after a transfer timing signal indicating a timing when the packet is inputted is received.

13. The packet processor system as claimed in claim 3 wherein the program execution controller does not execute a command acquisition for predetermined command execution clocks after a transfer timing signal indicating a timing when the packet is inputted is received.

14. The packet processor system as claimed in claim 13 wherein the predetermined command execution clocks comprise a command acquisition position.

15. The packet processor as claimed in claim 1 wherein the program execution controller determines a command acquisition position based on an internal state of the packet processor itself and the program.

16. The packet processor system as claimed in claim 2 wherein the program execution controller determines a command acquisition position based on an internal state of the packet processor itself and the program.

17. The packet processor as claimed in claim 15 wherein the internal state comprises an allowable command number or an executable command number.

18. The packet processor system as claimed in claim 16 wherein the internal state comprises an allowable command number or an executable command number.

19. The packet processor system as claimed in claim 5 wherein the execution program holder is capable of switching over a bank, and the internal state comprises a bank value.

20. The packet processor system as claimed in claim 3 wherein by a finish of a packet in processing or an input of a new packet, the program execution controller stops acquiring a next command for the packet.

21. The packet processor system as claimed in claim 3 wherein the program execution controller does not execute a command acquisition for predetermined command execution clocks.

22. The packet processor system as claimed in claim 5 wherein the program execution controller determines a command acquisition position based on an internal state of the packet processor itself and the program.
